(19) United States
(12) Patent Application Publication
(10) Pub. No.: US 2006/0043685 A1
(43) Pub. Date: Mar. 2, 2006

(54) Universal bit and tool holder for a linear-to-rotational motion converting device

(76) Inventor: Burton Kozak, Chicago, IL (US)

Correspondence Address: CHERSKOV & FLAYNIK;The Civic Opera Building, Suite 1777, 20North Wacker Drive, Chicago, IL, 60606, US

(21) Appl. No.: 10/925,819

(22) Filed: Aug. 25, 2004

(51) Int. Cl. B23B 31/12

(52) U.S. Cl. 279/137

(57) ABSTRACT

A universal chuck for devices that convert linear motion to rotary motion features a socket that accommodates standard tool bits, bits having a myriad of cross-section shapes, and other accessories that are presently used with a wide array of tools. The socket allows quick engagement of these bits and accessories.

### BACKGROUND OF THE INVENTION

1. Field of the Invention

The present invention relates to the field of tools or devices that drive interchangeable bits and, more particularly, to devices that convert linear motion to rotary motion.

2. Background of the Invention

Devices that convert linear motion to rotary motion are quite common. Typically these devices (e.g. “Yankee screwdrivers”) include a chuck that is designed to hold a specifically designed bit. Different manufacturers may utilize different chucks so that the device user is constrained to using only the bits provided by the device manufacturer. This has limited the usage of devices that convert linear motion to rotary motion in spite of these devices' obvious advantages.

Moreover, and as illustrated in FIG. 1, labeled as Prior Art, the typical chuck comprises two spring-actuated jaws that grip onto wings 2 or protrusions, extending radially from the periphery of a bit 3. Typically these protrusions 2 are circumferentially arranged near the heel 4 of the bit. The opposite end 6 of the bit 3 defines a blade, socket or other configuration to mate with a work piece. As depicted in FIG. 1, the protrusion portion of the bit is typically a large distance from the tip of the bit. This is because typical chucks do not accommodate stubby or relatively short bit lengths.

The protrusion configuration has the distinct disadvantage of applying torque but on a limited protruding portion of the bit. This leads to wear and tear on the bit and a tendency of the bit to cam out. This arrangement also produces a large counter-torque on the jaws and the actuating spring and this results in wear and tear on the system.

A myriad of tools exist for modifying an existing Yankee screwdriver. Once such tool is disclosed in U.S. Pat. No. 4,413,937. The '937 patent provides adaptors to be received at one end by a chuck already containing a bit so that the tool can use another bit. The '937 patent is primarily provided to allow one-hand bit changing operations.

U.S. Pat. No. 4,224,969 facilitates the coupling of a drill chuck to the end of a Yankee Screwdriver chuck. The '969 patent allows for myriad bits to be attached to the screwdriver.

Both the '937 and '969 patents require additional devices for use in combination with a Yankee Screwdriver to expand the utility of the screwdriver. These additional devices are prone to loss, dropping, and mis-alignment with the parent Yankee Screwdriver.

A need exists in the art for a universal chuck for devices that convert linear motion to rotary motion. The chuck would be integrally incorporated with a Yankee Screwdriver. The chuck would accommodate standard tool bits and other accessories that are presently used with a wide array of tools. Also, the chuck would be easy to manipulate to afford rapid change-out of bits.

### SUMMARY OF THE INVENTION

It is an object of the present invention to provide a universal chuck for devices that convert linear motion to rotary motion that overcomes many of the disadvantages of the prior art.

Another object of the present invention is to provide a universal chuck for devices that convert linear motion to rotary motion that limits longtime wear and tear on the chuck or on the bits and accessories used therewith. A feature of the present invention is a noncircular, polygonal (hexagonal, square, etc.) chuck that receives a bit or accessory. An advantage of the present invention is that it allows application of torque to the bit or accessory over a wide surface thus limiting the strain at any point on the chuck or on the bit or accessory. Another advantage of the present invention is that it allows the use of a multitude of standard tool bits and other accessories, having circular or non-circular cross sections that are presently used with a wide array of tools.

It is a further object of the present invention to provide a universal chuck for devices that convert linear motion to rotary motion that allows quick interchange between bits and other accessories used in conjunction with the device. It is a feature of an embodiment of the present invention that it includes a polygonal socket wherein bits and accessories may be slid in and out while held solely by friction. It is a feature of an alternate embodiment of the present invention that it includes a ball detent mechanism for holding bits and accessories. An advantage of the present invention is that it allows bit/accessory engagement with the chuck by means of a single snap-fit motion.

Yet another object of the present invention is to provide a chuck for a Yankee screw driver-type tool which accommodates bits of any length. A feature of the chuck is the incorporation of a collet. An advantage of the chuck is that, unlike a ball-detent mechanism, the collet engages and secures any length bit along the entire periphery of the bit.

Briefly, the invention provides a long-lasting universal chuck for devices that convert linear motion to rotary motion that accommodates standard tool bits and other accessories that are presently used with a wide array of tools and that allows quick engagement of these bits and devices.

### BRIEF DESCRIPTION OF THE DRAWING

The foregoing invention and its advantages may be readily appreciated from the following detailed description of the invention, when read in conjunction with the accompanying drawing in which:

FIG. 1 is a perspective view of a prior art bit for use in typical longitudinal/rotary driven hand tools;

FIG. 2 is a perspective view of a device that converts linear motion to rotary motion embodying a universal chuck for standard tool bits and other accessories in accordance with features of the present invention;

FIG. 3 is a perspective view of a device that converts linear motion to rotary motion embodying a universal chuck for standard tool bits and other accessories together with a representative sample of such bits and accessories in accordance with features of the present invention;

FIG. 4 is a cross-sectional view taken along lines 4-4 of FIG. 1, showing a universal chuck for devices that convert linear motion to rotary motion in accordance with features of the present invention;

FIG. 5 depicts a cross section of a Yankee screwdriver with a collet-containing chuck, in accordance with features of the present invention;

FIG. 6 is a view of FIG. 5 taken along line 6-6;

FIG. 7 is a schematic diagram of a storage handle, taken along line 7-7 of FIG. 5, in accordance with features of the present invention; and

FIG. 8 is a view of FIG. 7 taken along lines 8-8.

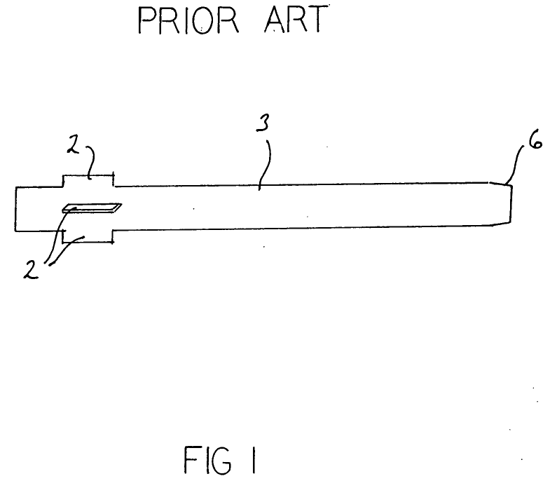

### DETAILED DESCRIPTION OF THE INVENTION

The present invention provides a long-lasting universal chuck for devices that convert linear motion to rotary motion that accommodates standard tool bits and other accessories that are presently used with a wide array of tools and that allows quick engagement of these bits and devices.

Chuck Configuration Detail

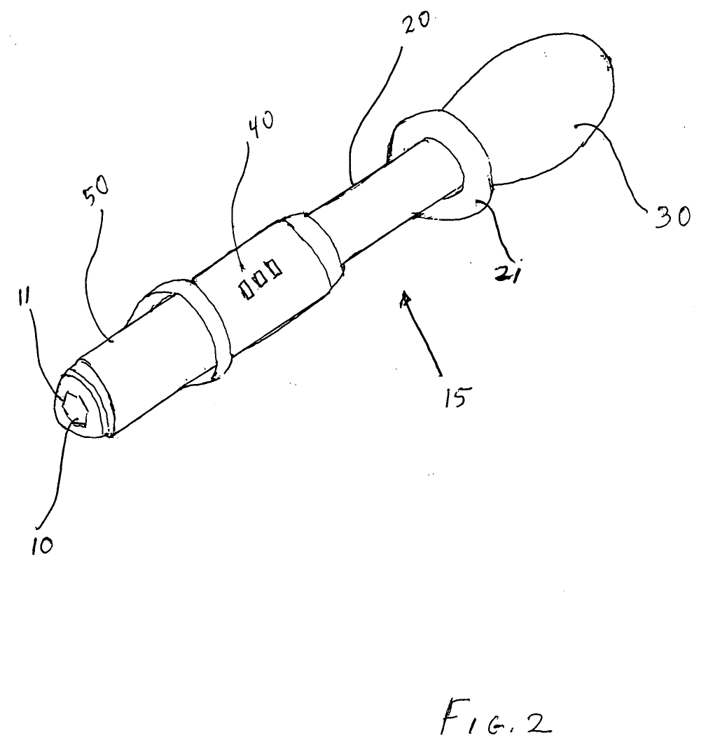

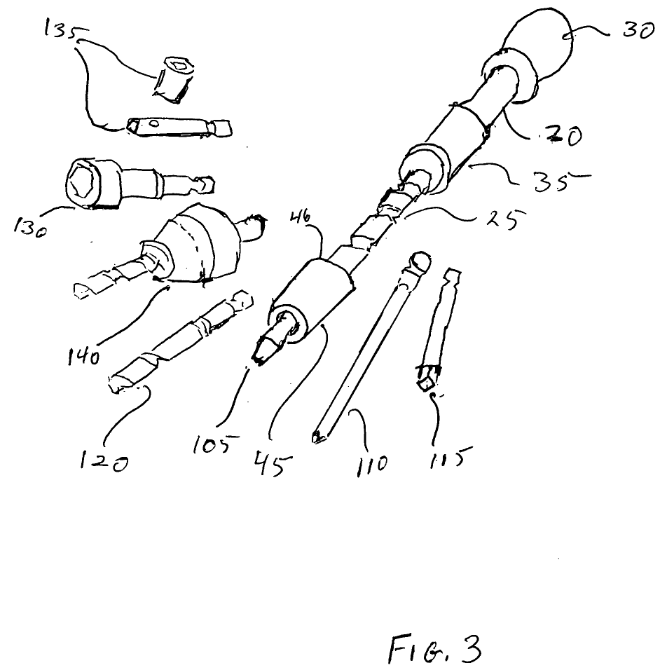

As shown in FIG. 2, the invented chuck, generally designated as 10, is part of a conventional device 15 that converts linear motion to rotary motion and that is shown here in a retracted position. The device 15 comprises a cylindrical sleeve 20 encasing a drive-shaft 25 (not visible in FIG. 2, but see FIG. 3). A first end 21 of the sleeve 20 terminates with a handle 30 and at a second end with the chuck 10.

Intermediate the handle and chuck is positioned a conventional mechanism that determines the orientation in which the drive shaft 25 rotates when a longitudinal force is applied to the handle 30. The orientation of the rotation is selected by means of a three-position manual switch 40 (clockwise rotation, no rotation, counterclockwise rotation). A proximal end 46 (See. FIG. 3) of the chuck 10 is attached to the drive-shaft 25. This confers coordinated rotation between the drive shaft 25 and the chuck 10 upon axial movement of the handle toward a workpiece when the device is coupled to said work piece. A knurled outside surface 50 radially disposed outwardly of the chuck allows a user to grip the chuck with her free hand (the other hand already holding the handle 30).

The chuck 10 defines a polygonal (hexagonal, square, etc.) opening 11. FIG. 3 illustrates the wide array of bits and accessories that may be accommodated by the chuck 10. These include conventional screwdriver bits: flat blade 105, Philips 110, Allen-head 115, drill bits 120, nut drivers 130, wrench sockets 135, as well as a drill-bit chuck 140 that allows the use of a myriad of drill bits and countersinks. The only requirement for these bits and accessories is that they have at their heel (i.e. at the end opposite to their driving end) a standard polygonal (hexagonal, square, etc.) or circular cross-section shaft.

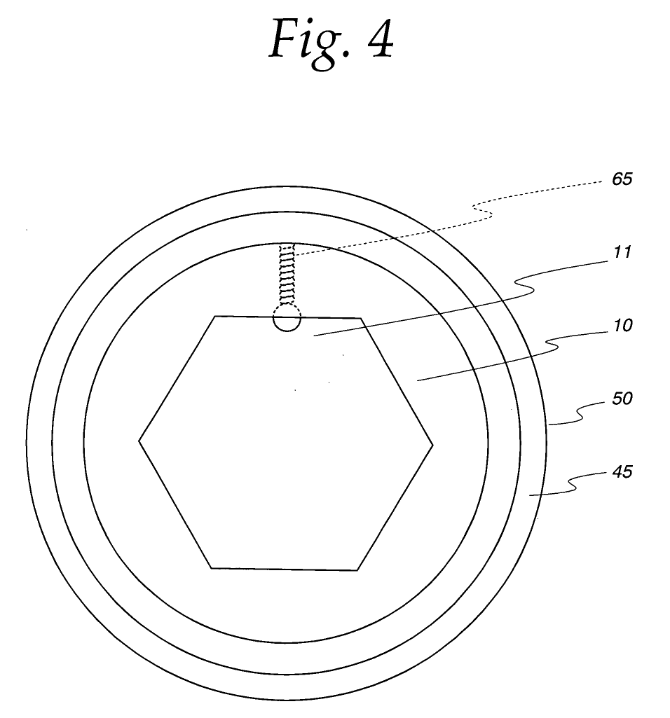

Friction may be used to secure the bits/accessories within the chuck. An alternate embodiment of the invention comprises a ball detent mechanism 65 (See FIG. 4) to secure the bits/accessories within the chuck. Ideally, bits and accessories to be used with this embodiment are provided with a collar 150 adapted to be received in the ball detent mechanism. Placement of the ball detent mechanism can vary, with placement close to the mouth of the chuck warranted in instances where shorter bits are to be utilized.

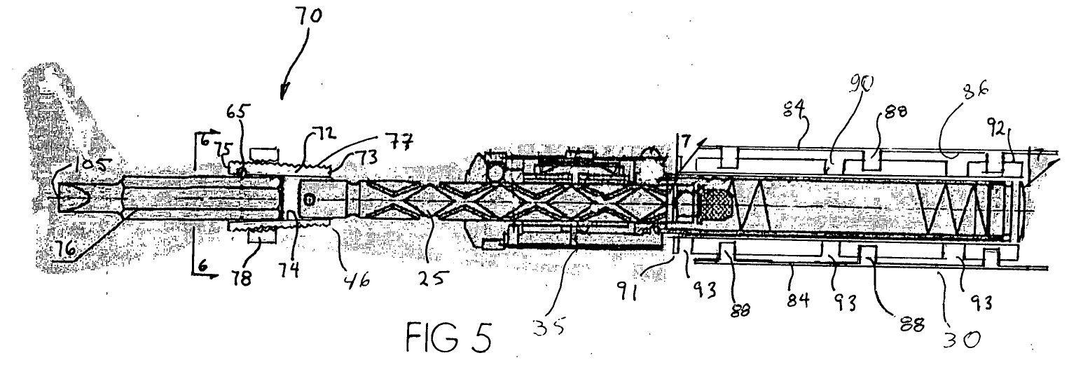

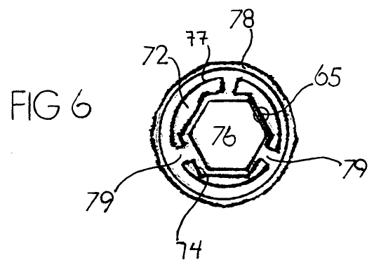

As depicted in FIG. 5 and in FIG. 6, which is a view of FIG. 5 taken along line 6-6, as an alternative to, or in combination with, a ball-detent mechanism, a modified 70 chuck defines a tapered collet 72 with a longitudinal axis which is to be seen as having a plurality of slots 79 extending parallel to the axis. The slots begin approximately midway between a first end 73 and second end 75 of the collet and extend in a direction opposite the location of the handle 30 of the tool and to the second end 75. The first end 73 of the collet 72 is attached proximally to the tool via tack welds, or reversibly attached via pins. The collet has an inner surface 74 defining a cross section in mating relationship with the cross section geometry of a tool bit 76. The topography of an exterior surface 77 of the collet 72 includes threads which matingly receive a threaded collar 78. As the collar advances axially and distally along the collet, the interior surface of the collet constricts so as to frictionally engage and hold a bit, heretofore inserted into the chuck. As such, the inner surface of the collet is dimensioned sufficiently close to the outer dimensions of the bit so as to be tightly secured to the bit when the collar is threaded to a tightened position.

Inasmuch as this collet configuration can secure any length bit, it obviates the need for placement of a ball-detent mechanism near the mouth of the chuck. However, the modified chuck 70 is depicted with the ball-detent mechanism 65, thereby conferring greater bit-holding force, particularly in situations where circular cross-section bits are to be held secure.

The handle 30 of the invented tool is defined to store and/or display bits when the bits are not in use. As such, the handle defines circumferentially arranged, longitudinally extending slots which frictionally engage and secure the bits while simultaneously allowing the user to view the stored bits. A preferred embodiment for this bit storage configuration is depicted in U.S. Pat. No. 6,435,065 B2, and incorporated herein by reference.

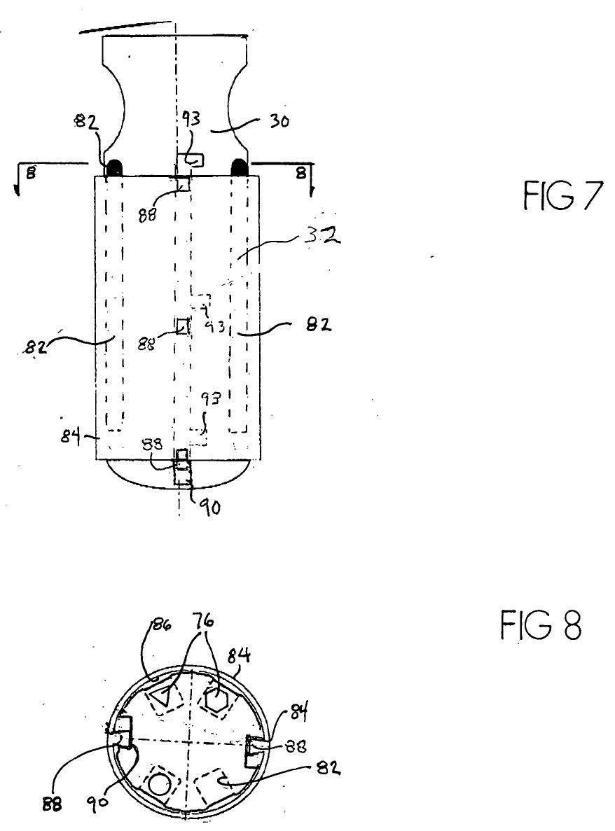

In an alternative embodiment, and as depicted in FIGS. 5 and 7, the handle defines circumferentially-arranged, longitudinally extending slots 32 adapted to receive bits. The bits are maintained within the slots by a sleeve overlaying the slots. The sleeve 84 is in slidable communication with the handle 30. The sleeve slides along the surface of the handle in an axial direction, from a first position whereby the sleeve substantially covers the bit-holding slots, to a second position whereby the bits and slots are sufficiently exposed to allow extraction of the bits from the bit-holding slots.

An inner surface 86 of the sleeve 84 defines a plurality of projections 88 which protrude inwardly toward the longitudinal axis of the handle. These projections 88 are configured to slide within channels 90 formed in the handle. Distal portions of the ridges define a cross section which is wider than a proximal portion of the ridges so as to resemble a flared configuration. This flared distal portion is adapted to be received by complementarily-shaped proximal portions of the channels, those proximal portions displaced radially and inwardly from the surface of the handle. The mating of the flared distal portions of the ridges with the complementarily-shaped channels provides a means for preventing the slide from detaching from the handle surface.

In close spatial relation to a first end 91 and a second end 92 of the channel 90 are recesses 93 which are medially offset at approximately right angles from the longitudinal axis of the channel 90. Another recess can be positioned intermediate the first end and second end. These recesses are adapted to receive the projections 88 when the sleeve is first positioned axially so that the projections are opposing the openings of the recesses and then rotated in the direction of the offset of the recesses. As such, these recesses provide a means for locking the sleeve 84 so as to prevent the sleeve from inadvertently sliding axially during the push-pull operation of the tool.

A heel portion of the handle 30 is configured to provide access to an interior cavity defined by the handle housing. As such, the heel defines a substrate in hinged communication with the bulk of the handle. Alternatively, the heel defines a removable substrate. The periphery of the substrate threadably mates with an inner surface of the heel-end of the handle, and specifically with a region of the heel-end defining an opening into the cavity. The cavity can be utilized for a myriad of purposes, including the storage of additional bits, a magnetic pick-up, or other accessories.

While the invention has been described with reference to details of the illustrated embodiment, these details are not intended to limit the scope of the invention as defined in the appended claims.

The embodiment of the invention in which an exclusive property or privilege is claimed is defined as follows:

1. A universal chuck for devices that convert linear motion to rotary motion, whereby the chuck is adapted to receive a bit having any cross section geometry.

2. The chuck as recited in claim 1 wherein said chuck comprises a combination ball detent and collet mechanism.

3. The chuck as recited in claim 2 wherein the collet is reversibly attached to the chuck.

4. The chuck as recited in claim 1 wherein said chuck defines a cross section shape selected from the group consisting of hexagonal, octagonal, rectangular, triangular, pentagonal, circular shapes and combinations thereof.

5. The chuck as recited in claim 1 wherein the chuck comprises:
a) a collet having a plurality of slots extending parallel to an axis the collet, wherein the collet has an inner surface defining a non-circular cross section and an exterior surface which contains threads; and
b) a threaded collar mated with said threads and adapted to advance axially along the collet, such that the interior surface of the collet constricts to secure a bit when the collar is advanced in a direction distal from the attachment of the bit to the chuck.

6. The chuck as recited in claim 5 wherein the collet is reversibly attached to the chuck.

8. The chuck as recited in claim 1 wherein said chuck comprises a ball detent mechanism.

9. The chuck as recited in claim 1 wherein said chuck comprises a collet mechanism.

10. A tool for transferring linear motion to rotary motion, the tool comprising:
a) a chuck at a first end of the tool, the chuck having an axis and adapted to receive a bit having any cross section configuration, the chuck comprising a collet to prevent the bit from moving rotationally relative to the chuck;
b) a handle at a second end of the tool, the handle adapted to receive and store bits.

11. The tool as recited in claim 10 wherein the handle further comprises:
c) a first surface defining a plurality of cavities for holding bits; and
d) a sleeve in slidable communication with said first surface.

12. The tool as recited in claim 10 wherein the collet is reversibly attached to the chuck.

13. The tool as recited in claim 10 wherein said chuck defines a cross section shape selected from the group consisting of hexagonal, octagonal, rectangular, triangular, pentagonal, circular shapes and combinations thereof.

14. The tool as recited in claim 10 wherein said chuck further comprises a ball detent mechanism to prevent the bit from moving parallel to the axis relative to the chuck.

15. A tool for transferring linear motion to rotary motion, the tool comprising:
a) a chuck at a first end of the tool, the chuck having an axis and adapted to receive a bit having any cross section configuration, the chuck comprising a ball detent mechanism to prevent the bit from moving parallel to the axis relative to the chuck;
b) a handle at a second end of the tool, the handle adapted to receive and store bits.

16. The tool as recited in claim 15 wherein the handle further comprises:
c) a first surface defining a plurality of cavities for holding bits; and
d) a sleeve in slidable communication with said first surface.

17. The tool as recited in claim 15 wherein the chuck further comprises a collet to prevent the bit from moving rotationally relative to the chuck.

18. The tool as recited in claim 17 wherein the collet is reversibly attached to the chuck.

19. The tool as recited in claim 10 wherein said chuck defines a cross section shape selected from the group consisting of hexagonal, octagonal, rectangular, triangular, pentagonal, circular shapes and combinations thereof.
